(19) United States
(12) Patent Application Publication
(10) Pub. No.: US 2008/0220363 A1
(43) Pub. Date: Sep. 11, 2008

(54) DEVELOPING ROLLER AND IMAGE FORMING METHOD USING THE SAME

(75) Inventors: Satoshi UCHINO, Tokyo (JP); Masahiro ANNO, Tokyo (JP); Takeo OSHIBA, Tokyo (JP); Okushi OKUYAMA, Tokyo (JP); Shinya OBARA, Tokyo (JP); Ryuichi HIRAMOTO, Tokyo (JP); So MATSUYA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/041,762

(22) Filed: Mar. 4, 2008

(30) Foreign Application Priority Data
Mar. 9, 2007 (JP) 2007059780

(51) Int. Cl. G03G 13/16; G03G 15/08

(52) U.S. Cl. 430/125.5; 399/286

(57) ABSTRACT

A developing roller for electrophotographic image forming apparatus is disclosed. The developing roller has a shaft and a resin layer, and the resin layer comprises a binder resin, a resin particle having a particle diameter of 5 μm to 30 μm and a content of from 10% to 50% by weight with respect to the resin layer, and inorganic oxide particles having a number based average primary particle diameter of 5 nm to 100 nm and a content of 1% to 40% by weight with respect to the resin layer. An image forming method employing the developer roller is also disclosed.

This application is based on Japanese Patent Application No. 2007-059780 filed on Mar. 9, 2007, in Japanese Patent Office, the entire content of which is hereby incorporated by reference.

### TECHNICAL FIELD

The present invention relates to a developing roller to be used for electrophotographic image forming apparatuses such as copying machines, printers and facsimile receiving machines, and particularly relates to a developing roller composed of a shaft and a resin layer containing particles provided on the shaft and to an image forming method using the developing roller.

### TECHNICAL BACKGROUND

In usual image forming method by electrophotographic system, a toner image is formed on an image receiving sheet by the following procedure. An electrostatic image formed on an image carrier, typically an electrophotographic photoreceptor, is developed by supplying an electrically charged toner. The toner image formed on the image carrier formed by developing is transferred onto an image receiving sheet. And then the toner image on the image receiving sheet is fixed by fixation to form the toner image on the image receiving sheet.

The developing method for forming the toner image on the image carrier includes a two-component developing method using a two-component developer composed of a carrier and a toner and a one-component developing method using a one-component developer composed of only a toner. Among them, in a developing method using an one-component non-magnetic developer which is one of the one-component developing methods, the toner is triboelectrified by a charging member provided near a developing roller or the developing roller itself and formed in a thin layer state on the surface of a developing roller and flied to the image carrier. The image forming method using the non-magnetic one-component toner is particularly effectual means for spreading full color printers on the market because a toner image can be formed on the image carrier by using a simple developing device without use of any carrier.

In the image forming technology using the non-magnetic one-component toner, investigation on the developing roller is carried out for raising the toner supplying ability to the image carrier. For example, a technique is known in which it is tried to raise the toner transporting ability of the roller by giving roughness on the surface of the roller by adding particles into the resin layer; cf. Patent Publication 1 for example. The type of such the technique is that for uniformly giving the roughness on the roller surface, for example, a method for adding the particles so that the ununiformity of the positional distribution of the ten-point roughness or the average interval of the irregularity is made into a specified range has been investigated; Patent Publication 2 for example. Moreover, investigation for improving the electrifying ability of the roller such as that by adding oxide particles such as titanium oxide for controlling the electroconductivity of the roller is carried out; cf. Patent Publication 3 for example.

Patent Publication 1: JP-A H07-064387

Patent Publication 2: JP-A 2003-207967

Patent Publication 3: JP-A 2003-195601

Suitable image formation is difficultly continued for long period by releasing the particles when the developer roller given roughness by the addition of the particles is used. Unevenness in the roughness of the roller is caused by the releasing of the particles and the amount of the toner transferred is fluctuated. As a result of that, a portion where the designated amount of the toner is not supplied occurs so that a printed image having unevenness in the density is formed.

As above-described, the developing roller having the resin layer containing the particles causes the problem of the releasing of the particles. However, concrete countermeasure for solving such the problem is almost not taken. It is difficult to perform stable image formation without image defect, particularly in the image formation by the non-image one-component method in which pressure is applied on the developing roller.

### SUMMARY OF THE INVENTION

An object of the invention is to provide a developing roller containing particles in the resin layer thereof from which the particles are not released off so that suitable images can be stably formed without fluctuation of the image quality, and an image forming method using the developing roller.

Namely, the object is to provide a developing roller and an image forming method by which the variation in the density of printed images is not caused when the printing is continuously carried out and images without density unevenness and image contamination can be stably printed.

An aspect of the invention is the developing roller including an electroconductive shaft and a resin layer containing a resin particle and inorganic oxide particles on the shaft, wherein the resin particles have a number based primary particle diameter of from 5 μm to 30 μm in an amount of from 10% to 50% by weight in the resin layer, and the inorganic oxide particles have an number based average primary particle diameter of from 5 nm to 100 nm in an amount of from 1% to 40% by weight in the resin layer.

The another aspect of the present invention is an image forming method comprising the steps of forming a developer layer on the developing roller as described above by a developer comprising a toner, and developing an electrostatic latent image formed on an image carrier by the toner of the developer layer.

### BRIEF DESCRIPTION OF THE DRAWING

FIG. 1(a) shows the developing roller of the invention.

FIG. 1(b) and FIG. 1(c) each shows examples of the schematic cross section view of the developing roller of the invention.

FIG. 2 shows the cross section of a developing device usable in the invention.

FIG. 3 shows the cross section of an image forming apparatus in which the developing device of FIG. 2 can be installed.

### THE DETAILED DESCRIPTION OF THE INVENTION

An aspect of the invention is the developing roller including an electroconductive shaft and a resin layer containing a resin particle and inorganic oxide particles on the shaft, wherein the resin particles have a number based primary particle diameter of from 5 μm to 30 μm in an amount of from 10% to 50% by weight in the resin layer, and the inorganic oxide particles have an number based average primary particle diameter of from 5 nm to 10 nm in an amount of from 1% to 40% by weight in the resin layer.

Another aspect of the invention is the developing roller including an electroconductive shaft and a resin layer containing resin particles and inorganic oxide particles on the shaft, wherein the resin particles have an average particle diameter of from 5 μm to 30 μm and a content thereof in the resin layer is from 10% to 50% by weight, and the inorganic oxide particles has an average particle diameter for from 5 nm to 100 nm and a content thereof in the resin layer is from 1% to 40% by weight.

The number based primary particle diameter of the resin particles is preferably 50 to 4,000 times of number based average primary particle diameter that of the inorganic oxide particles.

The content of the resin particles is preferably from 0.25 to 2.50 times or that of the inorganic oxide particles.

The resin layer is formed preferably by the coating on the electroconductive shaft.

The developing roller is used for an image forming method using a one-component developer.

The image forming method comprising the steps of forming a developer layer on a developing roller by a developer comprising a toner, and developing an electrostatic latent image formed on an image carrier by the toner of the developer layer.

The other embodiment is an image forming method comprising the steps of forming a developer layer solely composed of a toner on a developing roller and developing an electrostatic latent image formed on an image carrier by the toner forming the developer layer, wherein the developing roller has a shaft and a resin layer containing particles provided thereon the shaft in which the particles comprises resin particles and inorganic oxide particles and the resin particles has a number based primary particle diameter of from 5 μm to 30 μm and a content thereof in the resin layer is from 10% to 50% by weight and the inorganic oxide particles has an average particle diameter for from 5 nm to 100 nm and a content thereof in the resin layer is from 1% to 40% by weight.

The developing roller having the resin layer containing the particles in the resin layer thereof, which does not cause releasing off of particle, can be realized by the invention. As a result of that, toner images without fluctuation of the image density during continuous printing, density unevenness and image contamination can be obtained. Particularly, suitable toner images without any fault can be stably formed in the image formation by the non-magnetic one-component developing system in which pressure is applied onto the developing roller.

The developing roller of the invention comprises the electroconductive shaft and the resin layer containing the particles. In the invention, the specified resin particles and the inorganic oxide particles are used in combination for preventing the releasing off the particles from the surface of the roller.

It is supposed as the result of the investigation by the inventors on the cause of the releasing of the particles that the releasing is accelerated by homogeneous dispersion of the particles in the resin layer. Namely, it is supposed that the particles are coagulated with together when the dispersing of the particles is not suitable and the coagulated particles are crushed when pressure is applied to the developing roller so as to cause the releasing of the particles.

It is found out by the inventors as a result of investigation for finding the condition for easily homogeneously dispersing the particles in the resin layer that the homogeneous dispersion can be attained by the use of the resin particles and the inorganic oxide particles under the specified condition. It is observed that the particles are homogeneously dispersed by observing the developing roller of the invention and the coating liquid for forming the resin layer.

It is presumed that the coating liquid is changed to a non-Newtonian fluid by the addition of the inorganic oxide nano-particles and the sedimentation of the particles is inhibited though the reason of that the homogeneous dispersion of the particles can be realized by the above constitution is not cleared. Namely, it is presumed that the inorganic oxide particles support the resin particles so as to inhibit the sedimentation and coagulation of the particles caused by the sedimentation is avoided. Moreover, it is presumed that the inorganic oxide particles are made to be difficultly neared with together in the coating liquid by the presence of the resin particles so as to inhibit the coagulation of the inorganic oxide particles. It is presumed that the sedimentation and the nearing of the particles are avoided by formation of such the environment in the coating liquid and the uniformity of the dispersed particles is resulted for a long duration.

The invention is described in detail below.

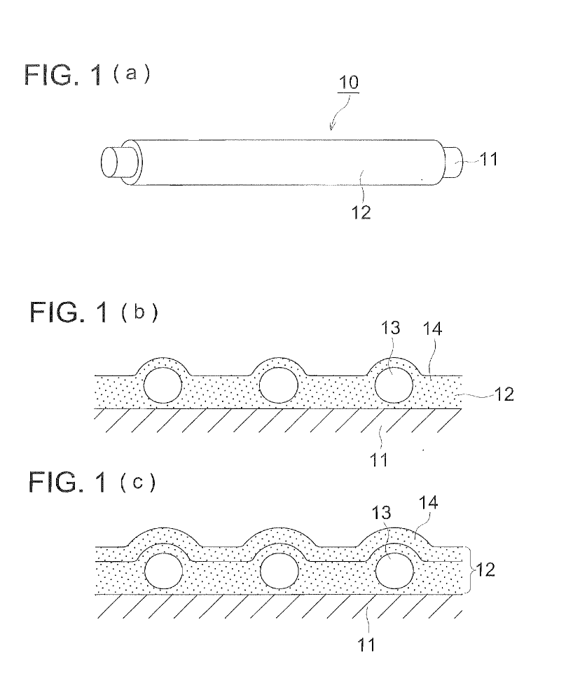

The developing roller relating to the invention has at least one resin layer provided on an electroconductive shaft. A cross section of a typical constitution of the developing roller relating to the invention is displayed in FIG. 1. FIG. 1(b) shows one having one resin layer around the shaft, and FIG. 1(c) is one having a plural resin layers. The developing roller relating to the invention is not limited to that having the cross section structure displayed in FIG. 1.

The developing roller 10 is constituted by the electroconductive shaft 11, hereinafter also simply referred to as the shaft, and the resin layer 12 provided on the shaft 11, and the resin layer 12 contains the resin particles 13 and the inorganic oxide particles 14.

The shaft 11 is constituted by an electroconductive material which is preferably a metallic material such as stainless steel such as SUS304, iron aluminum, nickel, an aluminum alloy and a nickel alloy. An electroconductive resin composed of resin filled by an electroconductive material such as the powder of the above metal and carbon black is usable. The electroconductive shaft having a relative resistivity of not more than 1×10⁴ Ω·cm is preferable, and the external diameter of the shaft is preferably from 5 mm to 30 mm and more preferably from 10 mm to 20 mm.

The resin particles contained in the resin layer 12 has a number based primary particle diameter of from 5 μm to 30 μm and preferably 10 μm to 20 μm, and the content thereof in the resin layer 12 is from 10% to 50% by weight. The resin particles preferably has a number based average primary particle diameter is of from 5 μm to 30 μm and preferably 10 μm to 20 μm. The inorganic oxide particles 14 has a number based average primary diameter of from 5 nm to 100 nm and preferably 10 nm to 50 nm, and the content thereof in the resin layer is from 1% to 10% by weight.

The resin particles can raise the toner transporting ability of the developing roller by giving the roughness onto the surface of the developing roller. As the material of the rein particle usable in the invention, styrene resin, styrene-acryl copolymer resin, polyester resin, polyurethane resin and acryl resin are cited in concrete thought the material is not specifically limited.

The resin particle 13 is preferably one which does not receive influence of the solvent such as swelling because the resin layer 12 is formed by coating on the shaft. Therefore, the resin particle 13 is preferably one having a structure excellent in the anti-solvent ability such as a crosslinked structure is particularly preferred, for example, an acryl resin having the crosslinked structure is one of the particularly preferable materials.

In the invention, the toner can be suitably transported on the roller surface by making the size of the resin particles into the above ranges. Namely, the sufficient amount of the toner can be held and transported on the developing roller by the use of the resin particle having a number based primary particle diameter of from 5 μm to 30 μm and preferably from 10 μm to 20 μm. As a result of that, the designated amount of the toner is constantly supplied on the image carrier so that the suitable toner image having the designated density with out any unevenness can be stably can be formed. Suitable irregularity cannot be provided on the roller surface by the resin particles having the diameter of less than 5 μm and the toner transporting ability of the roller is influenced. When the diameter of the resin particles exceeds 30 μm, the irregularity is made excessively deep and the supply of the toner becomes difficult.

When the content of the resin particles 13 is within the above range, the resin particles 13 are suitably dispersed in the resin layer 12 and uniform amount of the toner can be transported. The resin particles 13 are homogeneously dispersed in the resin layer 12 by making the content of the resin particles into the range of from 10% to 50% by weight and more preferably from 15% to 40% by weight, and the toner can be transported in the same amount at any portions on the surface of the developing toner. As a result of that, the electrification of the toner at the same level can be performed at any portions on the developing roller so that the toner is stably supplied onto the image carrier. When the content of the resin particles 13 is less than 10% by weight, the amount of the resin particles is too small and the transportation of the toner is difficultly performed on the developing roller. When the content of the resin particles is exceed 50% by weight, the resin particles are easily coagulated with together in such the environment and the homogeneous dispersion of rein particles 13 in the resin layer 12 is made difficult.

The diameter of the resin particle 13 is the number based primary particle diameter. In concrete, 100 resin particles are randomly observed as primary particles by a transmission electron microscope (TEM) with a magnitude of 1000 and the Fere diameter in the horizontal direction is calculated by image analysis and the maximum diameter particles is defined as the number based primary particle diameter.

In concrete, a sliced sample having a thickness of 200 nm is prepared from the developing roller 10 and the sample was observed by the transmission electron microscope (TEM) and the diameter of the resin particles 13 is calculated by analysis of thus obtained electron microscopic photography. As the concrete example of the transmission electron microscope, H-9000NAR manufactured by Hitachi Ltd., and JEM-200FX manufactured by JEOL Ltd. can be cited.

The observation by the transmission electron microscope is carried out by the usual method applied for the measurement of the cross section of the developing roller. The following procedure can be applied for example. First, a specimen for observation is prepared. The developing roller is buried in a room temperature curable epoxy resin and the resin is cured for preparing a block. The block is sliced into a slice having a thickness of from 80 to 200 nm by a microtome having a diamond blade to obtain a specimen for measurement.

Then the cross section structure of the developing roller is photographed by using the transmission electron microscope. The cross section structure of the developing roller can be visually observed by thus obtained microscopic photograph. The diameter of the resin particles can be calculated by processing the image information by an image processing apparatus such as Luzex F manufactured by Nireco Corp. connected with the transmission electron microscope. The specimen for measurement may be dyed by ruthenium tetraoxide or triosmium tetraoxide according to necessity.

Next, the inorganic oxide particle 14 contained in the resin layer 12 is described. The average diameter of the inorganic oxide particles is within the range of from 5 nm to 100 nm. The material of the inorganic oxide particle is not specifically limited and cerium oxide, chromium oxide, aluminum oxide, magnesium oxide, silicon oxide, tin oxide, zirconium oxide, iron oxide, zinc oxide and titanium oxide are cited as examples of it. Among them, silicon oxide, titanium oxide, zinc oxide, aluminum oxide and zirconium oxide are preferable and titanium oxide is particularly preferred. Titanium oxide includes one having the crystal state of anatase type, rutile type or brucite type and one having amorphous structure and the anatase type titanium oxide is particularly preferred.

Inorganic oxide particles subjected to a surface treatment are usable. The surface treatment of the inorganic oxide particles is carried out by the use of a silicon atom containing compound such as silicone oil typified by methylhydrogenpolysiloxane and a silane coupling agent typified by trimethylsilylizing agent. The dispersion state of the resin particles can be further improved by the addition of the inorganic oxide particles treated by such the silicon atom containing compound.

As one of the compounds usable for surface treatment of the inorganic oxide compound, a trimethylsilylizing agent is cited. The trimethylsilylizing agent is represented by Formula 1 or Formula 2.

((CH₃)₃Si)₂NR Formula 1

In the above formula, R is a hydrogen atom or a lower alkyl group.

(CH₃)₃SiY Formula 2

In the above formula, Y is a halogen atom, an —OH group, an —OR′ group or an —NR₂ group, R′ is the same as R in Formula 1.

As the lower alkyl group represented by R in the above Formula 1, an alkyl group having 1 to 5 carbon atoms such as a methyl group, an ethyl group and a propyl group is applicable. Ones having 1 to 3 carbon atoms are preferable and a methyl group is particularly preferred. As the halogen atom represented by Y, chlorine, fluorine, bromine and iodine are cited.

As concrete example of the trimethylsilylizing agent represented by Formula 1, hexamethyldisilazane, N-methyl-hexamethylsilazane, hexamethyl-N-propylsilazane are cited, among them hexamethylsilazane is preferable.

Concrete examples of the trimethylsilylizing agent represented by Formula 2 include trimethylchlorosilane, trimethylsilanol, methoxytrimethylsilane, ethoxytrimetylsilane, propoxytrimethylsilane, dimethylaminotrimethylsilane and triethylaminotrimethylsilane. Among them, trimethylsilanol is preferred.

In the surface treatment method using the trimethylsilylizing agent, the inorganic oxide particles are made react with the trimethylsilylizing agent in the presence of water vapor and the reaction is performed under a partial pressure of water vapor of from 2 to 20 kPa and preferably from 5 to 15 kPa.

The average diameter of the inorganic oxide particles 14 is within the range of from 5 nm to 100 nm.

The content of the inorganic oxide particles 14 in the resin layer 12 is from 1% to 40% by weight of the resin layer and preferably from 5% to 25% by weight of the resin layer. The inorganic oxide particles 14 forms suitable dispersed state without coagulation with together in the coating liquid by making the content within the above range. It is supposed that as a result of the above the inorganic oxide particles functions for homogeneous dispersing the resin particles 13 in the coating liquid.

It is supposed that non-Newtonian fluid property is given to the coating liquid by the inorganic oxide particles when the size and the content of the inorganic oxide particles are within the above ranges so that the sedimentation of the resin particles 13 is inhibited and the coating can be carried out while maintaining the uniform dispersed state. When the size of the inorganic oxide particles is less than 5 nm, the particles is not homogeneously dispersed and coagulated in the coating liquid so that the inorganic oxide particles cannot assist dispersion of the resin particles and the releasing of the particles is caused. When the size of the inorganic oxide particles exceeds 100 nm, the non-Newtonian fluid property is not given to the coating liquid and the sedimentation of the resin particles in the coating liquid cannot be prevented. When the content of the inorganic oxide is less than 1% by weight, the viscosity of the coating liquid cannot be raised no longer, and when the content exceeds 40% by weight, the inorganic oxide particles are neared and coagulated with together and so that the effects of the invention cannot be realized.

The diameter of the inorganic oxide particles is a number based average primary particle diameter. In concrete, 100 particles are randomly observed by the transmission electron microscope with a magnitude of 100,000 times as the primary particle and Fere diameter in the horizontal direction is calculated and defined as the number average primary particle diameter as the same as the measurement of the diameter of the resin particles. When plural kinds of the inorganic oxide particles are used, 100 particles of each of the kinds of the particles are observed by the above procedure and the number average diameter of each kind of the inorganic oxide particles is determined.

The relation of the resin particles and the inorganic oxide particles usable in the invention is described below. The resin particles 13 and the inorganic oxide particles 14 have the relation that the diameter of the resin particles 13 is from 50 to 4,000 times as large as the average diameter of the inorganic oxide particles. Namely, the diameter of the resin particles 13 contained in the resin layer 12 is from 50 to 4,000 times, preferably from 50 to 1,000 times, and more preferably from 100 to 400 times as large as average diameter of the inorganic oxide particles 14. Also, the resin particles 13 and the inorganic oxide particles 14 have the relation that number based average primary particle diameter of the resin particles 13 is from 50 to 4,000 times preferably from 50 to 1,000 times, and more preferably from 100 to 400 times as large as average diameter of the inorganic oxide particles 14.

When the coating liquid satisfying the above relation is coated on the shaft 11, the coating can be smoothly carried out by the effect of the non-Newtonian fluid property thereof. It is presumed that the coated layer is formed while the resin particles 13 are suitably dispersed state after the coating by the effect of the non-Newtonian fluid property so as that the resin layer 12 can be formed, in which the resin particles are homogeneously dispersed. It is also presumed that the sedimentation of the resin particles 13 in the coating liquid by the weight themselves is avoided by the non-Newtonian fluid property caused by the inorganic oxide particles and the homogeneous dispersion of the resin particles 13 in the coating liquid can be maintained. By such the action, the resin layer 12 in which the rein particles are homogeneously dispersed is formed on the shaft 11. Therefore, it is considered that the transportation amount of the toner by thus prepared developing roller has not partiality and uniformly charging can be carried out so that the suitable toner images without density unevenness can be obtained.

The content of the resin particles 13 in the resin layer 12 is within the range of from 0.25 to 2.50 times of that of the inorganic oxide particles 14. Namely, the content of the resin particles 13 is from om25 to 2.50 times, preferably from 0.25 to 2.00, and more preferably from 0.50 to 1.50 times of that of the inorganic oxide particles. Sufficient transportation and charging can be performed by the roller surface of thus prepared developing roller when the contents of them satisfy the above relation. Consequently, suitable images without ununiformity in the density can be stably formed. It is considered that the suitable dispersion state without coagulation of the resin particles can be obtained in the coating liquid by the effect of the non-Newtonian fluid property so that the coating liquid can he coated on the shaft 11 while maintaining the suitable dispersion state of the resin particles 13.

The resin layer forms the toner layer on the surface thereof and gives charge by triboelectricity. Moreover, strong adhesion force is required between the resin layer 12 and the shaft 11.

As an example of resin capable of realizing such the property, polyurethane resin obtained by reaction of a polyol and an isocyanate can be cited. A chain extension agent can be added additionally to the polyol and the isocyanate on the occasion of the preparation of the polyurethane resin.

Concrete examples of the polyol include polyol compounds for polyurethane such as poly(tetraethylene ether glycol), poly-ε-caprolactonediol, polycarbonatepolyol and polypropyleneglycol. Among them, polycarbonatepolyol is preferred, which forms polyurethane resin capable of preventing lowering in the charging amount of the toner at the image formation under high temperature and high humidity conditions. Concretely, an aliphatic or alicyclic polycarbonate polyol such as polyhexamethylenecarbonate diol is preferable.

As the concrete examples of the isocyanate, 4,4′-diphenylmethane diisocyanate (MDI), cyclohexane diisocyanate, hydrogenated MDI, isophorone diisocyanate, 1,4-xylene diisocyanate, 2,4-tolylene diisocyanate and 2,6-tolylene diisocyanate can be cited.

Urethane prepolymers can be used, which is obtained by making reaction using the above isocyanate, polyol and polyamine so as to have isocyanate group at the terminal of the molecule thereof.

As the chain expanding agent, ethylene glycol, propylene glycol, 1,4-butanediol, 1,6-hexanediol, ethylenediamine, trimethylenediamine, tetramethylenediamine, hexamethylenediamine, isophoronediamine (IPDA) and hydrazine are cited.

As the typical production method of the polyurethane resin, a one step method and a two step method are applicable. In the one step method, the polyurethane is produced by once reaction of the polyol and the isocyanate compound and, according to necessity, the chain expanding agent and a polymerization stopper in a suitable solvent. In the two step method, a prepolymer is prepared by reaction of the polyol with the diisocyanate compound under presence of excessive isocyanate groups and the reaction of the prepolymer is carried out in the suitable solvent in presence of presence of the chain expanding agent and the polymerization stopper. The two step method has a merit that a uniform polymer solution can be easily obtained.

As the solvent to be used for production of the polyurethane resin, an aromatic solvent such as benzene, toluene and xylene; an ester type solvent such as ethyl acetate and butyl acetate; an alcohol type solvent such as methanol, ethanol, isopropanol, n-butanol and diacetone alcohol; a ketone type solvent such as acetone, methyl ethyl ketone and methyl isobutyl ketone; and dimethylformamide, dimethylacetamide, ethylene glycol dimethyl ether, tetrahydrofuran and cyclohexanone are cited. These solvents can be used singly or in mixture.

The adhesion of the resin layer 12 with the shaft 11 can be also raised by adding a compound having a molecular structure formed by unifying a resin component and a silica component so called as a resin-silica hybrid to the resin layer 12. The resin-silica hybrid is constituted by a region having a net-like silica structure (also referred to as silica skeleton in the invention) formed by alternative bonding of silicon atoms and oxygen atoms and a region of organic polymer composed of polyurethane resin or vinyl polymer resin.

The resin-silica hybrid is produced by forming an alkoxyl group-containing silane-modified resin by reaction of a resin having a functional group capable of reacting with an epoxy group and curing the alkoxyl group-containing silane-modified resin by condensation reaction for forming the silica structure.

Polyamide resin may be employed for the resin layer. A preferable example includes DIAMID® X4685 provided by Daicel Degussa.

The thickness or the resin layer is preferably from 1 to 30 μm and that from 5 to 20 μm is particularly preferred. The thickness of the resin layer can be measured by taking a cross section specimen including the resin layer form the developing roller and observing the microscopic photograph of the sample. The developing layer may have a multi-layer structure composed of plural layers as shown in FIG. 1(c).

The thickness of the layer is an average value of thickness measured at 20 portions which does not contain resin particles as shown in FIG. 1(b) or FIG. 1(c) by a thickness meter. The thickness described in Example of this application was measured by employing an eddy current thickness meter Fischerscope, manufactured by Fischer. Any instruments may be employed as far as the same measuring accuracy is obtained.

Resin particles 13 are contained within a resin layer as demonstrated by FIGS. 1(b) or (c), and therefore, the resin particles are not exposed when surface of the resin layer wears a little, and a developing roller can be obtained which hardly generates image defects even after a plenty sheets of printing.

In the developing roller of the invention, an electroconductive material, typically carbon black, can be added into the resin layer 12. Some degree of electroconductivity is given to the resin layer 12 by adding the electroconductive material to the resin layer 12 so that the remaining charge generated on the roller surface can be easily leaked to the electroconductive shaft.

The production method of the developing roller relating to the invention is described below. The developing roller relating to the invention can be produced by coating the coating liquid comprising the resin containing the resin particles and the inorganic oxide particles around the electroconductive shaft and then subjecting to thermal treatment. Moreover, the multi-layer structured developing roller shown in FIG. 1(c) can be produced by coating a coating liquid on the above resin layer and applying the heating treatment the same as above. In this instance the upper layer may not contain the resin particles and/or the inorganic oxide particles.

The procedure for producing the developing roller is described below.

The coating liquid for forming the resin layer is prepared by mixing and dissolving the materials for forming the resin layer around the electroconductive shaft in the organic solvent. In the invention, the particles (the resin particles and the inorganic oxide particles) are added to the coating liquid prepared by dissolving the resin material for forming the resin layer to obtain the coating liquid. Carbon black can be added to the coating liquid to prepare the coating liquid.

In the invention, the coating liquid in which the resin particles and the inorganic oxide particles are homogeneously dispersed can be prepared by adding the resin particles and the inorganic oxide particles so as to satisfy the foregoing conditions.

It is required that the particles are homogeneously dispersed in the coating liquid. In the procedure for satisfying such the condition, for example, the inorganic oxide particles are primarily dispersed in the solvent and then secondarily dispersed by adding the resin material for forming the resin layer. As the means for homogeneous dispersing the inorganic oxide particles, for example, a media type dispersing machine is preferably applied for secondarily dispersing the particles. In concrete, a dispersion treatment using a sand grinder typified by Dyno-Mill TILAB, manufactured by Shinmaru Enterprises Corp., and glass beads with a diameter of 0.5 mm is applicable.

After the homogeneous dispersion of the inorganic oxide particles, the rein particles are added and subjected to a dispersion treatment to prepare the coating liquid. On the occasion for dispersing the resin particles, it is necessary to disperse the resin particles so that the particles are not crushed. Therefore, the dispersing of the resin particles is preferably performed under a condition more mild that that for dispersing the inorganic oxide particles. Thus the coating liquid containing the resin particles and the inorganic oxide particles for forming the resin layer is prepared.

After that, the above coating liquid for forming the resin layer is coated on the electroconductive shaft. The coating method can be selected from various methods according to the viscosity of the coating liquid for forming the resin layer. As the concrete coating method, a dipping method, a spray method, a roller coating method and a brush coating method can be applicable but the coating method is not limited to them.

After the coating of the coating liquid for forming the resin layer on the electroconductive shaft, the coated layer is dried and subjected to a thermal treatment at a temperature of from 120 to 200° C. for a time of from 20 to 90 minutes for removing the solvent to form the resin layer containing carbon black (electroconductive resin layer).

The multi-layered structure developing roller shown in FIG. 1(c) can be produced by coating a coating liquid, for example, one containing a silicone copolymer before or after the formation of the resin layer containing carbon black.

The image forming method relating to the invention is described below. The developing roller according to the invention is preferably applied for the image forming apparatus using the one-component type developer without the any carrier The developer is more preferably a non-magnetic one-component type developer.

The developing roller relating to the invention is installed in the developing device for supplying the toner onto the image carrier for forming the electrostatic latent image. The developing device has a toner regulation member and a toner supply assisting member additionally to the developing roller and these members are arranged to contacting to the developing roller. In the developing device, a thin layer of the toner is formed on the developing roller by the toner layer regulation member and the toner supply assisting member and supplied onto the image carrier for visualizing the latent image formed on the image carrier.

The toner layer regulation member supplies the toner in a uniform thin layer state onto the developing roller while pressing the developing roller and gives charge to the toner by friction. A material having some degrees of elasticity such as urethane rubber and a metal plate is used for the toner regulation member who forms the toner thin layer on the developing roller by pressing the developing roller. The thin layer of the toner formed on the developing roller has a thickness of not more than 10 particle thick and preferably not more than 5 particles thick of the toner.

The pressing force of the toner layer regulation member to the developing roller is preferably from 100 mN/cm to 5 N/cm and particularly preferably from 200 mN/cm to 4 N/cm. The toner can be transported without occurrence of unevenness of the transportation by making the pressure into the above range and the image fault such as white lines can be avoided. Moreover, the toner can be supplied onto the developing roller without loading for deforming or crushing the toner by making the pressure into the above range. The pressing force to the developing roller can be set at desired value by controlling the material constituting the toner regulation member and the length or thickness of the member on the occasion of image formation.

The toner supply assisting member is one for stably supplying the toner to the developing roller. As the toner supply assisting member, for example, a water wheel-like roller having a stirring wing or a sponge roller are usable. The diameter of the toner supply assisting member is preferably from 0.2 to 1.5 times of the diameter of the developing roller. The toner is supplied just enough when the size of the toner supply assisting member is within the above range so that suitable images without any fault can be formed.

As the image carrier to be used in the image forming method relating to the invention, an inorganic photoreceptor, an amorphous silicon photoreceptor and an organic photoreceptor are cited. Among them, the organic photoreceptor is particularly preferable and that having multi-layered structure containing a charge transfer layer and a charge generation layer is preferred.

The developing device usable for the image forming method relating to the invention is concretely described bellow.

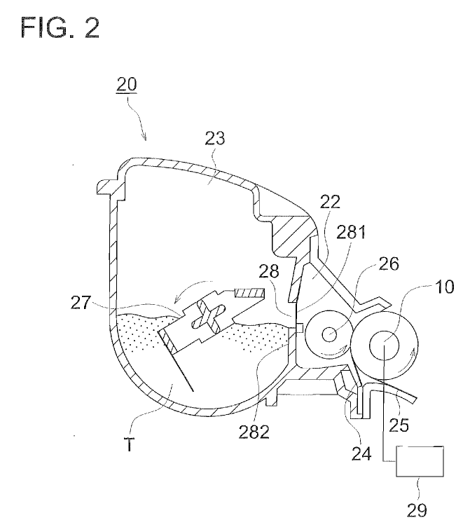

FIG. 2 shows the cross section of a developing device 20 usable in the image forming method of the invention.

The development using the non-magnetic one-component type toner (non-magnetic one-component developer) can be carried out by the use of the developing device 20 shown in FIG. 2. The developing device 20 has a developing roller 10 according to the invention, a buffer chamber 22 provided on the left side of the developing roller 10 and a hopper 23 adjacent to the buffer chamber 22. The developing roller 10 is driven in anti-clockwise direction in the drawing by a motor not shown in the drawing and touched or neared to the image carrier built-in the image forming apparatus.

The blade 24 as the toner regulation member is arranged in the buffer chamber 22 in a state of pressing to the developing roller 10. The blade 24 regulates the charging amount and adhering amount of the toner on the developing roller 10. A assistant blade 25 can be provided for assisting the regulation of the charging amount and the adhering amount of the toner on the developing roller 24 on the downstream side of the blade 24 to the rotating direction of the developing roller 10.

The supplying roller 26 is contacted by pressing to the developing roller 10. The supplying roller 26 is rotated in the same direction as that of the developing roller 10 (anti-clockwise direction in the drawing) by a motor not shown in the drawing. The supplying roller has a columnar base and a foamed layer made from urethane foam provided on the circumference of the base.

The hopper 23 contains toner T, which is a single component developer. A rotor 27 for stirring the tone T is provided in the hopper 23. The rotor 27 has a film-shaped transportation wing and transports the toner T by the rotation of it in the direction shown in the arrow. The toner T transported by the transportation wing is supplied to the buffer chamber through the hopper 23 and a path 28 provided on a partition parting the hopper 23 and the buffer chamber 22. The shape of the transportation wing is formed so that the wing is bended accompanied with the rotation while transporting the toner T at the front of the rotation direction and returned to straight when it is attained at the left end of the path 28. The wing supplies the toner T to the path 28 by bending and returning to straight of the shape thereof.

A regulation member 282 is attached at the other end of a valve 281. The regulation member 282 and the supplying roller 26 are arranged so as to remain a slight gap even when the path is closed by the valve 281. The regulation member 282 controls so that the amount of the toner accumulated at the bottom of the buffer chamber does not become excessive, which is adjusted so that the toner T recovered from the developing roller 10 to the supplying roller 26 is not excessively fallen to the bottom of the buffer chamber 22.

In the developing device 20, the developing roller 10 is rotated in the arrow direction and the toner in the buffer chamber 22 is simultaneously supplied onto the developing roller by the rotation of the supplying roller 26 on the occasion of image formation. The toner T supplied on the developing roller 10 is charged and made into a thin layer by the blade 24 and the assistant blade 25 and then transported to the portion facing to the image carrier and used for developing the latent image formed on the image carrier. The toner not used for the development is returned to the buffer chamber 22 accompanied with the rotation of the developing roller 10 and recovered by scraping off from the developing roller by the supplying roller 26.

A developing bias voltage supplying source 29 provided to the developing device is constituted by a direct current voltage supplying source outputting a designated developing bias voltage Vb (about 500 V for example) and a alternative current source forming an alternative electric field (a Vpp of 2.0 kV and a frequency of 2 kHz for example). Vpp is the peak-to-peak voltage representing the difference between the peak and the dip of the wave of the alternative voltage.

On the occasion of the image formation, the electrostatic image carrier 11 is uniformly charged at about 800 V, for example, by a charging device, not shown in the drawing, and then exposed to light at the designated portion by an optical head such as a laser. As a result of that, the charged potential is attenuated to about 100 V, for example, to form an electrostatic latent image.

In the developing zone, the toner forming the thin layer is flied from the circumference surface of the developing roller 10 to form powder cloud by the effect of the electric field generated by the developing bias voltage Vb applied from the developing bias voltage source 29 and the alternative voltage. Thus the toner is supplied onto the image carrier on which the electrostatic latent image is carried so that the electrostatic latent image is developed to form a toner image.

The thickness of the toner layer formed on the developing roller is controlled by setting the following conditions for example. Namely, the toner layer having a thickness of not more than 10 toner particle thick and preferably not more than 5 toner particle thick can be obtained by setting the circumference speed of the electrostatic latent image carrier 11 at 100 mm/sec, the circumference speed of the developing roller 10 at 200 mm/sec, the pressure of the toner regulation member 24 for pressing the developing roller at a value within the range of from 100 mN/cm to 5 N/cm and preferably from 200 mN/cm to 4 N/cm.

The constitution of the developing device in which the developing roller of the invention can be installed is not limited to that shown in FIG. 2.

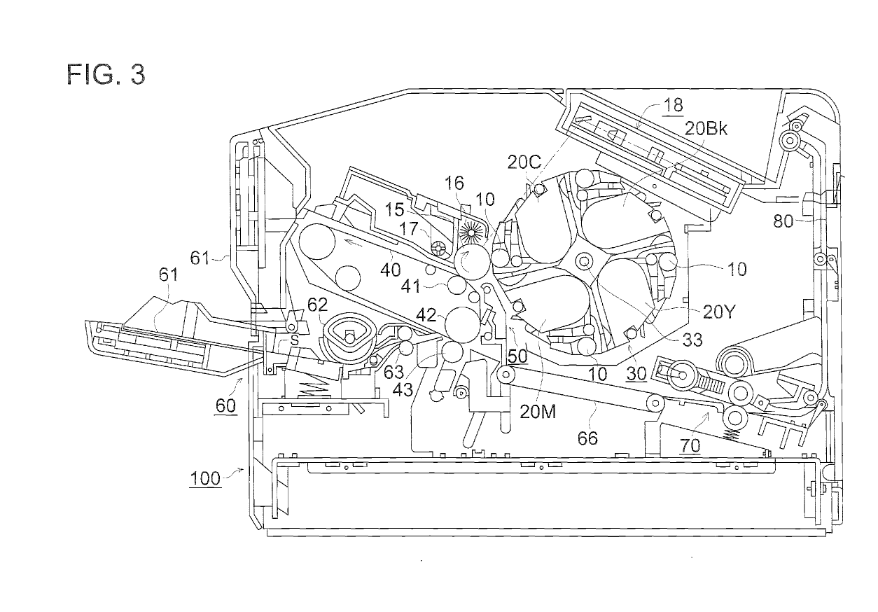

An example of the full color image forming apparatus in which the developing device 20 shown in FIG. 2 can be installed displayed in FIG. 3, provided that the image forming apparatus in which the developing device 20 is not limited to that displayed in FIG. 3. In the image forming apparatus shown in FIG. 3, a charging brush 16 for uniformly charging the surface of a photoreceptor drum 15 at a designated potential and a cleaner 17 for removing the toner remaining on the photoreceptor drum 11 are arranged around the photoreceptor drum 11.

A laser scanning optical system 18 scans on the photoreceptor drum 15 uniformly charged by the charging brush 16 for giving exposure to form an electrostatic latent image on the photoreceptor drum 15. The laser scanning optical system 18 has a laser diode, a polygon mirror and an fθ optical element and image data such as that of yellow, magenta, cyan and black are transported to a control means from a host computer. The laser beams each according to the image data of the each color are successively output for exposing by scanning on the photoreceptor drum 15 to form latent images of each of the colors.

A developing unit containing the developing device 20 relating to the invention supplies toners of each color to the photoreceptor drum 15 on which the electrostatic latent image is formed for performing the development. In the developing device unit 30, four developing devices 20Y, 20 M, 20C and 20Bk each containing non magnetic one-component toners of yellow, Magenta, cyan and black, respectively, are installed around the supporting axis 33 and the devices are introduced to the portion facing to the photoreceptor drum 15 by rotating around the axis 33.

The developing device unit 30 is rotated around the supporting axis 33 for every time of formation of the electrostatic latent image of each color so as to introduce the developing device 20 containing the corresponding color to the position facing to the photoreceptor drum 15. The development is carried out by successively supplying the charged toners of each color from the developing devices 20Y, 20M, 20C and 20Bk onto the photoreceptor drum 15.

In the image forming apparatus of FIG. 3, an endless intermediate transfer belt 40 synchronously rotating with the photoreceptor drum 15 is provided on the downstream side of the developing device unit 30 in the rotating direction of the photoreceptor drum 15. The intermediate transfer belt 40 is touched with the photoreceptor drum 15 at the position where the belt is pressed by a primary transfer roller 41 so as to receive the toner image formed on the photoreceptor drum 15. A rotatable secondary transfer roller 43 is provided at the position facing to the supporting roller 42 supporting the intermediate transfer belt 40 and the toner image carrying on the intermediate transfer roller 40 is transferred by pressing onto the recording material S such as recording paper at the position where the supporting roller 42 and the secondary transfer roller 43 are faced with together.

A cleaner 50 for removing the toner remaining on the intermediate transfer belt 40, which is touchable to and releasable from the intermediate transfer belt 40, is provided between the developing device unit 30 and the intermediate transfer belt 40.

A paper supplying means 60 for introducing the recording material S to the intermediate transfer belt 40 is constituted by a paper supplying tray for storing the recording material S, a paper supplying roller 62 for supplying one by one the recording material S stored in the paper supplying tray 61 and a timing roller 63 for conveying the supplied recording material S to the secondary transfer position.

The recording materials on which the toner image is transferred by pressing is conveyed to a conveying means 66 constituted by an air suction belt to a fixing device 70 and the toner image is fixed onto the recording material S. After the fixation, the recording material S is conveyed through the vertical conveying path 80 and taken out onto the housing of the apparatus 100.

### EXAMPLES

The embodiment of the invention is concretely described below referring examples though the invention is not limited to the examples.

### 1. Preparation of Developing Roller

Developing Rollers 1 to 28 were prepared according to the following procedure.

(1) Preparation of Developing Roller 1

| | |
|---|---|
| Furnace Black | 30 parts by weight |
| Anatase type titanium oxide particle (Number based | 8.5 parts by weight |
| average primary particle diameter: 35 nm, treated by | |
| methylhydrogenpolysiloxane on the surface) | |
| Methyl ethyl ketone(MEK) | 400 parts by weight |

The above materials were charged in the above order into a media type dispersing machine Dyno-Mill TILAB, manufactured by Shinmaru Enterprises Corp., and 100 parts by weight of glass beads having a diameter of 0.5 mm were further added, and the resultant mixture was subjected to dispersing treatment for 2 hours at 1,000 rpm to prepare a primary dispersion.

After that, 100 parts by weight of urethane resin, Nippolan 5120 manufactured by Nippon Polyurethane Industries Co., Ltd., was further charged into the dispersing machine and dispersed to prepare a secondary dispersion.

Into the above secondary dispersion, 21.1 parts by weight of cross-linked acryl resin particles (number based primary particle diameter: 15 μm) was added and dispersed at a rotation number for not crushing the cross-linked acryl resin particles are not crushed to prepare Resin Layer Coating Liquid 1.

Then Resin Layer Coating Liquid 1 was coated on the outer surface of a shaft of SUS 303 having a diameter of 16 mm so as to form a layer with a dry thickness of 10 μm and thermally treated at 130° C. for 1 hour to prepare Developing Roller 1 having the structure shown in FIG. 1(b).

### (2) Preparation of Developing Roller 2

Resin Layer Coating Liquid 2 was prepared in the same manner as in Resin Layer Coating Liquid 1 except that the content in the resin layer of anatase type titanium oxide particles, which had a number based average primary particle diameter of 100 nm and were treated by methylhydrogenpolysiloxane on the surface thereof, was changed to 40.0% by weight and the content in the resin layer of the cross-linked acryl resin particles having a number based primary particle diameter of 5 μm was changed to 10.3% by weight.

Then Resin Layer Coating Liquid 2 was coated on the outer surface of a shaft of SUS 303 having a diameter of 16 mm so as to form a layer with a dry thickness of 10 μm and thermally treated at 130° C. for 1 hour to prepare Developing Roller 2 having the structure shown in FIG. 1(b).

### (3) Preparation of Developing Roller 3

Resin Layer Coating Liquid 3 was prepared in the same manner as in Resin Layer Coating Liquid 1 except that the content in the resin layer of anatase type titanium oxide particles, which had a number based average primary particle diameter of 35 nm and were treated by methylhydrogenpolysiloxane on the surface thereof, was changed to 9.6 parts by weight and the adding amount of the cross-linked acryl resin particles having a number based primary particle diameter of 30 μm was changed to 21.1 parts by weight.

Then Resin Layer Coating Liquid 3 was coated on the outer surface of a shaft of SUS 303 having a diameter of 16 mm so as to form a layer with a dry thickness of 10 μm and thermally treated at 130° C. for 1 hour to prepare Developing Roller 3 having the structure shown in FIG. 1(b).

### (4) Preparation of Developing Roller 4

Resin Layer Coating Liquid 4 was prepared in the same manner as in Resin Layer Coating Liquid 1 except that the content in the resin layer of anatase type titanium oxide particles, which had a number based average primary particle diameter of 5 nm and were treated by methylhydrogenpolysiloxane on the surface thereof, was changed to 20.0% by weight and the content in the resin layer of the cross-linked acryl resin particles having a number based primary particle diameter of 20 μm was changed to 13.2% by weight.

Then Resin Layer Coating Liquid 4 was coated on the outer surface of a shaft of SUS 303 having a diameter of 16 mm so as to form a layer with a dry thickness of 10 μm and thermally treated at 130° C. for 1 hour to prepare Developing Roller 4 having the structure shown in FIG. 1(b).

### (5) Preparation of Developing Roller 5

Resin Layer Coating Liquid 5 was prepared in the same manner as in Resin Layer Coating Liquid 1 except that the content in the resin layer of anatase type titanium oxide particles, which had a number based average primary particle diameter of 60 nm and were treated by methylhydrogenpolysiloxane on the surface thereof, was changed to 40.0% by weight and the content in the resin layer of the cross-linked acryl resin particles having a number based primary particle diameter of 30 μm was changed to 11.0% by weight.

Then Resin Layer Coating Liquid 5 was coated on the outer surface of a shaft of SUS 303 having a diameter of 16 mm so as to form a layer with a dry thickness of 10 μm and thermally treated at 130° C. for 1 hour to prepare Developing Roller 5 having the structure shown in FIG. 1(b).

### (6) Preparation of Developing Roller 6

Resin Layer Coating Liquid 6 was prepared in the same manner as in Resin Layer Coating Liquid 1 except that the content in the resin layer of anatase type titanium oxide particles was changed to 30.0% by weight and the content of the cross-linked acryl resin particles was changed to 50.0% by weight.

Then Resin Layer Coating Liquid 6 was coated on the outer surface of a shaft of SUS 303 having a diameter of 16 mm so as to form a layer with a dry thickness of 10 μm and thermally treated at 130° C. for 1 hour to prepare Developing Roller 6 having the structure shown in FIG. 1(b).

(7) Preparation of Developing Roller 7

| | |
|---|---|
| Furnace Black | 20 parts by weight |
| Methyl ethyl ketone | 400 parts by weight |

The above materials were charged in the above order into the media type dispersing machine Dyno-Mill TILAB, manufactured by Shinmaru Enterprises Corp., and 100 parts by weight of glass beads having a diameter of 0.5 mm were further added, and the resultant mixture was subjected to dispersing treatment for 2 hours at 1,000 rpm to prepare a primary dispersion.

After that, 100 parts by weight of urethane resin, Nippolan 5120 manufactured by Nippon Polyurethane Industries Co., Ltd., was further charged into the dispersing machine and dispersed at 1,000 rpm to prepare Surface Layer Coating Liquid 1.

Surface Layer Coating Liquid 1 was coated on the resin layer prepared in the same manner as in Developing Roller 1 so that the dry thickness was became to 3 μm and subjected to a thermal treatment for 45 minutes at 130° C. to prepare Developing Roller 7 having the structure shown in FIG. 1(c).

### (8) Preparation of Developing Roller 8

Developing Roller 8 was prepared in the same manner as in Developing Roller 1 except that 8.5% by weight of anatase type titanium oxide with no surface treatment having a number based average primary particle diameter of 35 nm was used.

### (9) Preparation of Developing Roller 9

Resin Layer Coating Liquid 9 was prepared in the same manner as in Resin Layer Coating Liquid 1 except that the anatase type titanium oxide particle is not added, and Developing Roller 9 was prepared in the same procedure as in Developing Roller 1.

### (10) Preparation of Developing Roller 10

Resin Layer Coating Liquid 10 was prepared in the same manner as in Resin Layer Coating Liquid 1 except that the adding amount of anatase type titanium oxide particles was changed so as that the content of the titanium oxide in the resin layer became to 4.5% by weight and the adding amount of the cross-linked acryl resin particles was changed so that the content of the resin particles in the resin layer became to 12.0% by weight.

Then Resin Layer Coating Liquid 10 was coated on the outer surface of a shaft of SUS 303 having a diameter of 16 mm so as to form a layer with a dry thickness of 10 μm and thermally treated at 130° C. for 1 hour to prepare Developing Roller 10 having the structure shown in FIG. 1(b).

### (11) Preparation of Developing Roller 11

Resin Layer Coating Liquid 11 was prepared in the same manner as in Resin Layer Coating Liquid 1 except that the content in the resin layer of anatase type titanium oxide particles, which had a number based average primary particle diameter of 5 nm and were treated by methylhydrogenpolysiloxane on the surface thereof, was changed to 40.0% by weight and the content in the resin layer of the cross-linked acryl resin particles having a number based primary particle diameter of 30 μm was changed to 10.0% by weight.

Then Resin Layer Coating Liquid 10 was coated on the outer surface of a shaft of SUS 303 having a diameter of 16 mm so as to form a layer with a dry thickness of 10 μm and thermally treated at 130° C. for 1 hour to prepare Developing Roller 11 having the structure shown in FIG. 1(b).

### (12) Preparation of Developing Roller 12

Resin Layer Coating Liquid 12 was prepared in the same manner as in Resin Layer Coating Liquid 1 except that the content in the resin layer of anatase type titanium oxide particles, which had a number based average primary particle diameter of 100 nm and were treated by methylhydrogenpolysiloxane on the surface thereof, was changed to 5.3% by weight and the content in the resin layer of the cross-linked acryl resin particles having a number based primary particle diameter of 5 μm was changed to 14.0% by weight.

Then Resin Layer Coating Liquid 12 was coated on the outer surface of a shaft of SUS 303 having a diameter of 16 mm so as to form a layer with a dry thickness of 10 μm and thermally treated at 130° C. for 1 hour to prepare Developing Roller 12 having the structure shown in FIG. 1(b).

### (13) Preparation of Developing Roller 13

Resin Layer Coating Liquid 13 was prepared in the same manner as in Resin Layer Coating Liquid 1 except that the content in the resin layer of anatase type titanium oxide particles, which had a number based average primary particle diameter of 4 nm and were treated by methylhydrogenpolysiloxane on the surface thereof, was changed to 40.0% by weight and the content in the resin layer of the cross-linked acryl resin particles having a number based primary particle diameter of 35 μm was changed to 9.0% by weight.

Then Resin Layer Coating Liquid 13 was coated on the outer surface of a shaft of SUS 303 having a diameter of 16 mm so as to form a layer with a dry thickness of 10 μm and thermally treated at 130° C for 1 hour to prepare Developing Roller 13.

### (14) Preparation of Developing Roller 14

Resin Layer Coating Liquid 14 was prepared in the same manner as in Resin Layer Coating Liquid 1 except that the content in the resin layer of anatase type titanium oxide particles, which had a number based average primary particle diameter of 250 nm and were treated by methylhydrogenpolysiloxane on the surface thereof, was changed to 4.5% by weight and the content in the resin layer of the cross-linked acryl resin particles having a number based primary particle diameter of 4.5 μm was changed to 55.0% by weight.

Then Resin Layer Coating Liquid 14 was coated on the outer surface of a shaft of SUS 303 having a diameter of 16 mm so as to form a layer with a dry thickness of 10 μm and thermally treated at 130° C. for 1 hour to prepare Developing Roller 14.

### (15) Preparation of Developing Roller 15

Resin Layer Coating Liquid 15 was prepared in the same manner as in Resin Layer Coating Liquid 1 except that the content in the resin layer of anatase type titanium oxide particles, which had a number based average primary particle diameter of 35 nm and were treated by methylhydrogenpolysiloxane on the surface thereof, was changed to 30.0% by weight and the cross-linked acryl resin particles was not added.

Then Resin Layer Coating Liquid 15 was coated on the outer surface of a shaft of SUS 303 having a diameter of 16 mm so as to form a layer with a dry thickness of 10 μm and thermally treated at 130° C. for 1 hour to prepare Developing Roller 15.

### (16) Preparation of Developing Rollers 16-26

Each of Resin Layer Coating Liquid 16-26 was prepared in the same manner as in Resin Layer Coating Liquid 1 except that the number based average primary particle diameters of the anatase type titanium oxide particles were changed to that as shown in Table 1 and the number based primary particle diameters of the cross-linked acryl resin particles were also changed to that as shown in Table 1.

Then each of Resin Layer Coating Liquid 16-26 was coated on the outer surface of a shaft of SUS 303 having a diameter of 16 mm so as to form a layer with a dry thickness of 10 μm and thermally treated at 130° C. for 1 hour to prepare Developing Rollers 16-26, respectively.

### (17) Preparation of Developing Roller 27

Resin Layer Coating Liquid 27 was prepared in the same manner as in Resin Layer Coating Liquid 1 except that the metal oxide particles were replaced by rutile titanium oxide particles which had a number based average primary particle diameter of 35 nm and were treated by methylhydrogenpolysiloxane on the surface thereof.

Then Resin Layer Coating Liquid 27 was coated on the outer surface of a shaft of SUS 303 having a diameter of 16 mm so as to form a layer with a dry thickness of 10 μm and thermally treated at 130° C. for 1 hour to prepare Developing Roller 27.

### (18) Preparation of Developing Roller 28

Resin Layer Coating Liquid 28 was prepared in the same manner as in Resin Layer Coating Liquid 1 except that the polyurethane resin Nippolan 5120 manufactured by Nippon Polyurethane industries Co., Ltd., was replaced by a polyamide resin DIAMID, manufactured by Daicel Degussa, and the metal oxide particles were replaced by a rutile titanium oxide particles which had a number based average primary particle diameter of 35 nm and were treated by methylhydrogenpolysiloxane on the surface thereof. The resin particles were replaced by cross-linked styrene resin particles having a number based primary particle diameter of 15 μm.

Then Resin Layer Coating liquid 28 was coated on the outer surface of a shaft of SUS 303 having a diameter of 16 mm so as to form a layer with a dry thickness of 10 μm and thermally treated at 130° C. for 1 hour to prepare Developing Roller 28.

The resin particles, its primary particle diameter and the inorganic oxide particles and its number based average primary particle diameter, and the ratio of them and the ratio of the content of the Developing rollers 1-28 are listed in Table 1.

TABLE 1

| | | | Inorganic oxide | | | | |
|---|---|---|---|---|---|---|---|
| | | | particle | | | | |
| | Resin particle | | Average | | Ratio of these particles | | |
| | particle | Content | particle | Content | Surface | Ratio of | Ratio of |
| Developing | diameter | (Weight | diameter | (Weight | treatment | diameters | contents |
| Roller No. | A (μm) | percent) C | B (nm) | percent) D | Yes/No | (A/B) | (C/D) |
| 1 | 15 | 13.2 | 35 | 5.3 | Yes | 429 | 2.49 |
| 2 | 5 | 10.3 | 100 | 40.0 | Yes | 50 | 0.26 |
| 3 | 30 | 13.2 | 35 | 6.0 | Yes | 857 | 2.20 |
| 4 | 20 | 13.2 | 5 | 20.0 | Yes | 4000 | 0.66 |
| 5 | 30 | 11.0 | 60 | 40.0 | Yes | 500 | 0.28 |
| 6 | 15 | 50.0 | 35 | 30.0 | Yes | 429 | 1.67 |
| 7 | 15 | 10.2 | 35 | 4.1 | Yes | 429 | 2.49 |
| 8 | 15 | 13.2 | 35 | 5.3 | No | 429 | 2.49 |
| 9 | 15 | 13.2 | — | — | — | — | — |
| 10 | 15 | 12.0 | 35 | 4.5 | Yes | 429 | 2.67 |
| 11 | 30 | 10.0 | 5 | 40.0 | Yes | 6000 | 0.25 |
| 12 | 5 | 14.0 | 100 | 5.3 | Yes | 50 | 2.64 |
| 13 | 35 | 9.0 | 4 | 40.0 | Yes | 8750 | 0.23 |
| 14 | 4.5 | 55.0 | 250 | 4.5 | Yes | 18 | 12.22 |
| 15 | — | — | 35 | 30.0 | Yes | — | — |
| 16 | 5 | 13.2 | 5 | 5.3 | Yes | 1000 | 2.49 |
| 17 | 4 | 13.2 | 5 | 5.3 | Yes | 800 | 2.49 |
| 18 | 32 | 13.2 | 5 | 5.3 | Yes | 6400 | 2.49 |
| 19 | 5 | 13.2 | 15 | 5.3 | Yes | 333 | 2.49 |
| 20 | 4 | 13.2 | 100 | 5.3 | Yes | 40 | 2.49 |
| 21 | 5 | 13.2 | 105 | 5.3 | Yes | 48 | 2.49 |
| 22 | 30 | 13.2 | 105 | 5.3 | Yes | 286 | 2.49 |
| 23 | 32 | 13.2 | 100 | 5.3 | Yes | 320 | 2.49 |
| 24 | 30 | 13.2 | 100 | 5.3 | Yes | 300 | 2.49 |
| 25 | 30 | 13.2 | 4 | 5.3 | Yes | 7500 | 2.49 |
| 26 | 5 | 13.2 | 4 | 5.3 | Yes | 1250 | 2.49 |
| 27 | 15 | 13.2 | 35 | 5.3 | Yes | 429 | 2.49 |
| 28 | 15 | 13.2 | 35 | 5.3 | Yes | 429 | 2.49 |

A: number based primary particle diameter
B: number based average primary particle diameter

### 2. Preparation of Toner

(1) Preparation of Resin Dispersion 1

Into a monomer mixture composed of 115.1 g of styrene, 42.0 g of n-butyl acrylate and 10.9 g of acrylic acid was charged in a flask with a stirrer, 72.0 g of pentaerythritol tetrastearate was added and dissolved by heating at 80° C.

On the other hand, a surfactant solution composed of 2,760 g of deionized water and 7.08 g of anionic surfactant (sodium dodecylbenzenesulfonate: SDS) was charged into a separable flask to which a stirrer, a thermal sensor, a cooling tube and a nitrogen introducing device were attached, and heated by 80° C. while stirring at 230 rpm under nitrogen atmosphere. Then the surfactant solution (80° C.) and the foregoing monomer solution were mixed and dispersed by a mechanical dispersing machine having a circulation path, CLEARMIX manufactured by M Technique Ltd., to prepare an emulsion in which emulsified particles (oil droplets) having uniform particle diameter were dispersed.

An initiator solution prepared by dissolving 0.84 g of a polymerization initiator (potassium persulfate KPS) in 200 g of deionized water was added to the above dispersion and the system was heated and stirred for 3 hours at 80° C. for making polymerization reaction. To the resultant reacting liquid, a solution prepared by dissolving 7.73 g of the polymerization (KPS) in 240 g of deionized water was added. After 15 minutes, the liquid was adjusted to 80° C. and a mixed liquid composed of 83.6 g of styrene, 140.0 g of n-butyl acrylate, 36.4 g of methacrylic acid and 12 g of n-octylmercaptan was dropped to the liquid spending 100 minutes. The system was heated and stirred for 60 minutes at 80° C. and then cooled by 40° C. to obtain Resin Particle Dispersion 1, which contains wax.

(2) Preparation of Colorant Dispersion K

Into 160 g of deionized, 9.2 g of sodium n-dodecylsulfate was dissolved by stirring. Twenty grams of carbon black Mogal L manufactured by Cabot Corp. was gradually added and dispersed by the mechanical dispersing machine CLEARMIX manufactured by M Technique Ltd to prepare Colorant Dispersion K. The diameter of the colorant particle in Colorant Dispersion K was measured by an electrophoretic light scattering photometer ELS-800 manufactured by Otsuka Electronics Co., Ltd. The diameter was 120 nm in weight average particle diameter.

(3) Preparation of Colored Particle 1K

In a reaction vessel (four mouth flask) on which a thermal sensor, a cooling pipe, a stirrer having two wings with a crossing angle of 20° and a shape monitoring apparatus were attached, 1250 g in terms of solid component of Resin Particle Dispersion 1, 2,000 g of deionized water and whole amount of Colorant Dispersion K were charged and then a 5 mole/liter sodium hydroxide was added after the temperature was adjusted to 25° C. to adjust the pH to 10.0. Then a solution prepared by dissolving 52.6 g of magnesium chloride hexahydrate in 72 g of deionized water was added spending 10 minutes while stirring at 25° C. Just after that, the system was heated by 95° C. spending for 5 minutes at a heating rate of 14° C./minute.

The diameter of the coagulated particle was measured by Multisizer 3, manufactured by Beckman-Coulter Inc., in such the situation and the growing of the particles is stopped by adding an aqueous solution composed of 115 g of sodium chloride and 700 g of deionized water when the median diameter (D50) came up to 6.5 μm. Furthermore, the fusion was continued by ripening treatment by heating and stirring at a rotation rate of 120 rpm for 8 hours at 80° C. Then the system was cooled by 30° C. at a rate of 10° C./minute and the ph of the system was adjusted to 3.0 by adding hydrochloric acid, and then the stirring was stopped.

Thus prepared particles were filtered and repeatedly washed by deionized water and classified in the liquid by a centrifugal machine, and dried by a flash jet dryer to obtain Colored Particle 1K having a moisture content of 1.0% by weight.

(4) Preparation of Colorant Dispersion Y

Colorant Dispersion Y was prepared in the same manner as in Colorant Dispersion K except that 20 g of Carbon Black was replaced by 20 g of C. I. Pigment yellow 74. The diameter of the colorant particle in Colorant Dispersion Y measured by the electrophoretic light scattering photometer ELS-800, manufactured by Otsuka Electronics Co., Ltd., was 120 nm in the weight average particle diameter.

(5) Preparation of Colorant Dispersion M

Colorant Dispersion M was prepared in the same manner as in Colorant Dispersion K except that 20 g of Carbon Black was replaced by 20 g of a quinacridone type magenta pigment C. I. Pigment Red 122. The diameter of the colorant particle in Colorant Dispersion M measured by the electrophoretic light scattering photometer ELS-800, manufactured by Otsuka. Electronics Co., Ltd., was 120 nm in the weight average particle diameter.

(6) Preparation of Colorant Dispersion C

Colorant Dispersion C was prepared in the same manner as in Colorant Dispersion K except that 20 g of Carbon Black was replaced by 20 g of a phthalocyanine type cyan pigment C. I. Pigment Blue 15:3. The diameter of the colorant particle in Colorant Dispersion C measured by the electrophoretic light scattering photometer ELS-800, manufactured by Otsuka Electronics Co., Ltd., was 120 nm in the weight average particle diameter.

(7) Preparation of Colored Particle 1Y

Colored Particle 1Y was prepared in the same manner as in Colored Particle 1K except that whole amount of Colorant Dispersion K was replaced by the whole amount of Colorant Dispersion Y.

(8) Preparation of Colored Particle 1M

Colored Particle 1M was prepared in the same manner as in Colored Particle 1K except that whole amount of Colorant Dispersion K was replaced by the whole amount of Colorant Dispersion M.

(9) Preparation of Colored Particle 1C

Colored Particle 1C was prepared in the same manner as in Colored Particle 1K except that whole amount of Colorant Dispersion K was replaced by the whole amount of Colorant Dispersion C.

(10) Preparation of Toner

To each of the above colored particles, 0.8 parts by weight of hydrophobic silica having a number average primary particle diameter of 12 nm and a hydrophobicity of 65 and 0.5 parts by weight of hydrophobic titania having a number average primary particle diameter of 30 nm and a hydrophobicity of 55 were added and mixed by a Henschel mixer to prepare toners. The toners were each referred to as Toner 1K, Toner 1Y, Toner M1 and Toner C, respectively.

Evaluation experiments were carried out by using the prepared toners and the foregoing Developing Rollers 1 to 28. The pressure applying from the toner regulation member to the developing roller in the developing device was set at 3.5 N/cm.

### 3. Evaluation Experiments

For evaluation, imaged were formed by a color laser printer MAGICOLOR 5440DL manufactured by Konica Minolta Business Technology Inc. in which the developing devices using the above toners and Developing Rollers 1 to 28 were each used. As is shown in Table 2, experiments using the developing devices each installed with Developing Rollers 1 to 8, 10, 11, 12, 16, 19, 24, 27 and 28 were each referred to as Examples 1 to 16 and those using the developing devices each installed with Developing Rollers 9, 13, 14, 15, 17, 18, 20 to 23, 25 and 26 were referred to as Comparative Examples 1 to 12, respectively.

Images obtained at the initial time of printing and that obtained after printing of 3,000 prints were compared for evaluating the variation of the image density, density unevenness, electrifying property and image contamination between the initial and the completion time of printing. An A4 sized image having a pixel ratio of 20% (full color mode of yellow, magenta, cyan and black each having pixel ratio of 5%) was continuously printed for 3,000 times.

An original image having a pixel ratio of 6% (an A4 sized original image including of a halftone image, a full color portrait image, a solid white image and a solid black image each occupying ¼ area of the original image) was used for evaluation.

<Image Density Variation>

The variation between the density of solid black image formed on the initial print and that formed after continuous printing of 3,000 prints were evaluated. Reflective density was measured at arbitrarily selected 10 points on the solid black image by Macbeth Reflective Densitometer RD-918 and the average density was calculated from the densities at 8 point without 2 points each having the largest and smallest density. The image density variation was determined by the difference between the average density of the initial print and that of the print after the continuous printing and the difference of the densities of less than 0.15 was judged as acceptable.

<Image Density Unevenness>

The unevenness of the image density was evaluated on the halftone portion and the solid black portion of the evaluation image obtained after finishing of printing of 3,000 prints. Reflective densities were measured at 10 points each arbitrarily selected in each of the image portions by the Macbeth Reflective Densitometer RD-918 and the difference between the largest value and the smallest value among the measured densities was evaluated as the image density unevenness. A density difference in the halftone image portion of not more than 0.05 and that in the solid black image portion of not more than 0.10 were each judged as acceptable.

<Electricity Property>

Spilling of the toner in the apparatus and image breaking in the evaluation image after printing of 3,000 prints were visually evaluated.

A: Spilling of the toner and the breaking of image were not observed at all.

B: Spilling of the toner was not observed and breaking of the image was slightly observed at the tail end portion of the image but any problem was not caused in the practical use.

C: Spilling of the toner and breaking of the image were caused by insufficient electricity and problems were caused in the practical use.

Samples ranked as A and B were judged as acceptable.

<Image Contamination>

Ten prints printed just before the completion of printing 3,000 prints was visually observed for evaluation the image contamination caused by wearing and the degradation of the roller surface. Samples in which the number of prints having no contamination were judged as acceptable.

Results are listed in Table 2.

TABLE 2

| | | | Image density | | | |
|---|---|---|---|---|---|---|
| | | | unevenness | | | |
| | | Image | Halftone | | | Prints |
| | Developing | density | image | Solid black | Electricity | without |
| | roller No. | variation | portion | image portion | property | contamination |
| Example 1 | 1 | 0.07 | 0.02 | 0.05 | A | 9 |
| Example 2 | 2 | 0.10 | 0.04 | 0.08 | B | 9 |
| Example 3 | 3 | 0.07 | 0.03 | 0.06 | A | 9 |
| Example 4 | 4 | 0.08 | 0.02 | 0.05 | A | 10 |
| Example 5 | 5 | 0.10 | 0.05 | 0.09 | B | 10 |
| Example 6 | 6 | 0.09 | 0.04 | 0.08 | B | 10 |
| Example 7 | 7 | 0.03 | 0.01 | 0.02 | A | 9 |
| Example 8 | 8 | 0.05 | 0.03 | 0.04 | A | 9 |
| Example 9 | 10 | 0.10 | 0.05 | 0.09 | B | 9 |
| Example 10 | 11 | 0.10 | 0.05 | 0.08 | B | 8 |
| Example 11 | 12 | 0.09 | 0.05 | 0.09 | B | 8 |
| Example 12 | 16 | 0.09 | 0.04 | 0.06 | B | 9 |
| Example 13 | 19 | 0.08 | 0.04 | 0.05 | B | 10 |
| Example 14 | 24 | 0.09 | 0.05 | 0.05 | B | 10 |
| Example 15 | 27 | 0.08 | 0.03 | 0.06 | B | 10 |
| Example 16 | 28 | 0.10 | 0.05 | 0.09 | B | 10 |
| Comparative | 9 | 0.22 | 0.08 | 0.19 | C | 3 |
| Example 1 | | | | | | |
| Comparative | 13 | 0.18 | 0.07 | 0.17 | C | 4 |
| Example 2 | | | | | | |
| Comparative | 14 | 0.17 | 0.07 | 0.15 | C | 4 |
| Example 3 | | | | | | |
| Comparative | 15 | 0.28 | 0.11 | 0.23 | C | 2 |
| Example 4 | | | | | | |
| Comparative | 17 | 0.16 | 0.07 | 0.12 | C | 3 |
| Example 5 | | | | | | |
| Comparative | 18 | 0.17 | 0.07 | 0.14 | C | 3 |
| Example 6 | | | | | | |
| Comparative | 20 | 0.17 | 0.07 | 0.14 | C | 3 |
| Example 7 | | | | | | |
| Comparative | 21 | 0.17 | 0.07 | 0.13 | C | 4 |
| Example 8 | | | | | | |
| Comparative | 22 | 0.16 | 0.06 | 0.11 | C | 4 |
| Example 9 | | | | | | |
| Comparative | 23 | 0.16 | 0.06 | 0.12 | C | 3 |
| Example 10 | | | | | | |
| Comparative | 25 | 0.17 | 0.06 | 0.13 | C | 4 |
| Example 11 | | | | | | |
| Comparative | 26 | 0.16 | 0.07 | 0.11 | C | 4 |
| Example 12 | | | | | | |

As is shown in Table 2, the toner image formation without the density variation, density unevenness and contamination, even though there was some degree of difference, could be obtained in Examples 1 to 16 and it was confirmed that the developing rollers having the constitution of the invention had durability without releasing the resin particles from the roller. On the other hand, comparative examples 1 to 12 were entirely unacceptable in the all evaluation items.

It can be confirmed from the results of the examples that the developing roller having the constitution of the invention does not cause the lowering in the roller surface strength caused by wearing of the resin layer and releasing of the particles and has high durability.

1. A developing roller comprising an electroconductive shaft and a resin layer provided on the shaft, wherein the resin layer comprises a binder resin, a resin particle having a particle diameter of 5 μm to 30 μm in an amount of from 10% to 50% by weight of the resin layer, and inorganic oxide particles having a number based average primary particle diameter of 5 nm to 100 nm in an amount of 1% to 40% by weight of the resin layer.

2. The developing roller of claim 1, wherein the diameter of the resin particle is 50 to 4,000 times of the number based average primary particle diameter of the inorganic oxide particles.

3. The developing roller of claim 1, wherein a weight content of the resin particles is from 0.25 to 2.50 times of that of the inorganic oxide particles.

4. The developing roller of claim 1, wherein the number based average primary diameter of the inorganic oxide particles is 10 nm to 50 nm.

5. The developing roller of claim 1, wherein inorganic oxide of the inorganic oxide particles comprises at least one of cerium oxide, chromium oxide, aluminum oxide, magnesium oxide, silicon oxide, tin oxide, zirconium oxide, iron oxide, zinc oxide or titanium oxide.

6. The developing roller of claim 5, wherein the inorganic oxide of the inorganic oxide particles is silicon oxide, titanium oxide, zinc oxide, aluminum oxide or zirconium oxide.

7. The developing roller of claim 6, wherein inorganic oxide of the inorganic oxide particles is titanium oxide.

8. The developing roller of claim 7, wherein inorganic oxide of the inorganic oxide particles is anatase titanium oxide.

9. The developing roller of claim 1, wherein the inorganic oxide particles has been subjected to surface treatment.

10. The developing roller of claim 9, wherein the inorganic oxide particles has been subjected to surface treatment by a silane coupling agent.

11. The developing roller of claim 1, wherein the diameter of the resin particle is 10 μm to 20 μm.

12. The developing roller of claim 1, wherein a content of the resin particle is 15% to 40% by weight of the resin layer.

13. The developing roller of claim 1, wherein a resin of the resin particle includes at least one of a styrene, styrene-acryl copolymer, polyester, polyurethane and acryl resin.

14. The developing roller of claim 13, wherein the resin of the resin particle is an acryl resin having crosslinked structure.

15. The developing roller of claim 1, wherein a thickness of the resin layer is from 5 to 20 μm.

16. The developing roller of claim 1, wherein the binder resin is polyurethane or polyamide.

17. The developing roller of claim 1, wherein the resin layer is formed by coating a coating composition comprising a binder resin, a resin particle and inorganic oxide particles on an electroconductive shaft.

18. An image forming method comprising the steps of,
forming a developer layer on a developing roller of claim 1 by a developer comprising a toner, and
developing an electrostatic latent image formed on an image carrier by the toner of the developer layer.

19. The image forming method of claim 18, wherein the developer is a one-component developer.
